(19) United States
(12) Patent Application Publication
(10) Pub. No.: US 2017/0028324 A1
(43) Pub. Date: Feb. 2, 2017

(54) OIL STRAINER

(71) Applicant: MAHLE FILTER SYSTEMS JAPAN CORPORATION, Tokyo (JP)

(72) Inventors: Satoshi KOMIYAMA, Fujimi-shi (JP); Yuichi HAMADA, Sakado-shi (JP); Atsuki KUMAGAI, Sayama-shi (JP); Masahiro ARIYAMA, Yokohama-shi (JP)

(73) Assignee: MAHLE FILTER SYSTEMS JAPAN CORPORATION, Tokyo (JP)

(21) Appl. No.: 15/222,196

(22) Filed: Jul. 28, 2016

(30) Foreign Application Priority Data
Jul. 31, 2015 (JP) 2015-151412

(51) Int. Cl. B01D 35/00; B01D 39/10; B01D 35/30

(52) U.S. Cl. CPC B01D 35/005; B01D 35/30; B01D 39/10; B01D 2201/12; B01D 2201/18

(57) ABSTRACT

Oil strainer has a housing having a suction port and a discharge port and a filtration element dividing an inside of the housing into a suction port side and a discharge port side. The filtration element has a first filtration member having a coarse filter, a second filtration member having a fine filter and stacked at an upstream side or a downstream side of the first filtration member and a retainer plate having a plurality of oil pass openings and retaining the first and second filtration members. The retainer plate is stacked at a downstream side of the first and second filtration members. The second filtration member has at least one opening portion so that a part of the oil bypasses the second filtration member. One of the first and second filtration members has protruding and depressed portions that touch the other of the first and second filtration members.

### BACKGROUND OF THE INVENTION

The present invention relates to an oil strainer.

For instance, an oil pan storing oil as hydraulic fluid is provided at a lower side of an automatic transmission of a vehicle, and the oil in the oil pan is pumped up by an oil pump and circulated to each part. Since there is a case where the oil contains foreign matter such as metal, an oil strainer having a filtration member (a filter) to catch and remove the foreign matter is disposed at an upstream side of the oil pump.

Such an oil strainer is disclosed in Japanese Unexamined Patent Publication No. 2002-191914 (hereinafter is referred to as “JP2002-191914”). This oil strainer is formed from a housing, a retainer plate and a filtration member (a filter) that is made of nonwoven fabric and disposed in the housing. The filtration member is formed into an undulate shape (or a wavy form) having a number of beads in order to increase a filtering area.

Further, Japanese Patent No. 5260625 (hereinafter is referred to as “JP5260625”) discloses an oil filter apparatus using two kinds of filtration members (filter mediums) each having a different grain. A fine filter medium is positioned at an upstream side of an oil flow, and a coarse filter medium is positioned at a downstream side of the fine filter medium. These filter mediums are separately retained by spacers that are different members from the filter mediums.

Furthermore, Japanese Unexamined Patent Publication No. 2010-017706 (hereinafter is referred to as “JP2010-017706”) discloses a filter medium. In JP2010-017706, a tight or dense filter medium disposed at an upstream side in a filtration direction and an open filter medium are retained by a grid spacer formed from longitudinal and transverse struts with these filter mediums set apart from each other.

### SUMMARY OF THE INVENTION

However, in the case of a configuration in which the two kinds of filter mediums are separately retained by the spacers that are different members from the filter mediums, not only the spacers that overlap with the filter mediums become a resistance of an oil flow passage, but also an area used for the filtration is reduced since portions where the spacers are disposed do not contribute to the filtration.

Further, the use of the spacers as the different members from the filter mediums increases parts count, and the oil strainer gets complicated. In addition, weight of the oil strainer and weight of the automatic transmission provided with the oil strainer increase. Therefore, these are undesirable.

An object of the present invention is therefore to provide an oil strainer that is capable of solving the above problems.

According to one aspect of the present invention, an oil strainer comprises: a housing having a suction port and a discharge port; and a filtration element dividing an inside of the housing into a suction port side and a discharge port side and set so that oil flows from the suction port to the discharge port through the filtration element. The filtration element has (a) a first filtration member having a coarse filter, (b) a second filtration member having a fine filter and stacked at an upstream side or a downstream side of the first filtration member and (c) a retainer plate having a plurality of oil pass openings and retaining the first and second filtration members. The retainer plate is stacked at a downstream side of the first and second filtration members. The second filtration member has at least one opening portion so that a part of the oil bypasses the second filtration member. One of the first and second filtration members has protruding and depressed portions that touch the other of the first and second filtration members.

With this structure, it is possible to surely catch foreign matter by two kinds of filtration members each having a different grain. Further, by providing at least one opening portion at the second filtration member, a part of the oil bypasses the second filtration member through the opening portion without passing through the second filtration member. In addition, the first filtration member and the second filtration member are separately held by the protruding and depressed portions provided at one of the first and second filtration members.

In the present invention, the protruding and depressed portions are a plurality of pleats that are formed by shaping base material of the first filtration member or the second filtration member into an undulate shape (or a wavy form) by a bending or folding process (a pleating process). Oil passages defined between the pleats each communicate with the opening portion.

With this structure, the oil smoothly flows along the oil passages defined between the pleats to the opening portion.

In the present invention, the first filtration member is formed from a metal mesh and is disposed at the suction port side, and the second filtration member is formed from a nonwoven fabric and is disposed at the downstream side of the first filtration member.

With this structure, a relatively large foreign matter is caught or trapped by the first filtration member disposed at the upstream side, and minute or fine foreign matter is caught or trapped by the second filtration member disposed at the downstream side.

In the present invention, the second filtration member has a plurality of opening portions that are arranged so that the opening portions each correspond to the oil pass openings of the retainer plate. Or alternatively, the second filtration member has an opening portion that extends so as to partly communicate with oil pass openings.

With this structure, the oil bypasses the second filtration member through the opening portion. Further, since the opening portion communicates with the oil pass openings, the oil bypassing the second filtration member through the opening portion is smoothly lead to the oil pass openings.

According to the present invention, by providing the opening portion at the second filtration member, since a part of the oil bypasses the second filtration member through the opening portion, it is possible to surely catch the foreign matter by the two kinds of filtration members each having a different grain while reducing a resistance of an oil flow passage. Further, according to the present invention, since the first filtration member and the second filtration member are separately held by a shape or structure of the filtration member in itself, there is no need to provide spacers that are additional elements or components. This contributes to further reduction of the resistance of the oil flow passage. In addition, the oil can be filtered using an entire filtration area of the filtration member.

The other objects and features of this invention will become understood from the following description with reference to the accompanying drawings.

### BRIEF DESCRIPTION OF THE DRAWINGS

FIG. 1 is a perspective view of an oil strainer according to a first embodiment of the present invention.

FIG. 2 is a perspective exploded view of the oil strainer of the first embodiment.

FIG. 3 is a sectional view of the oil strainer, taken along a line A-A of FIG. 1.

FIG. 4 is an enlarged sectional view of the oil strainer of FIG. 3.

FIG. 5 is a perspective view showing a stacked or laminated filtration element.

FIG. 6 is a perspective exploded view of an oil strainer of a second embodiment.

FIG. 7 is a sectional view of the oil strainer of the second embodiment, taken along the same line as the line A-A of FIG. 1.

FIG. 8 is an enlarged sectional view of the oil strainer of FIG. 7.

FIG. 9 is a perspective exploded view of an oil strainer of a third embodiment.

FIG. 10 is a sectional view of the oil strainer of the third embodiment, taken along the same line as the line A-A of FIG. 1.

FIG. 11 is an enlarged sectional view of the oil strainer of FIG. 10.

FIG. 12 is a perspective view showing a stacked or laminated filtration element.

FIG. 13 is a perspective exploded view of an oil strainer of a fourth embodiment.

FIG. 14 is a perspective view showing a stacked or laminated filtration element.

FIG. 15 is a perspective exploded view of an oil strainer of a fifth embodiment.

FIG. 16 is a perspective view showing a stacked or laminated filtration element.

FIG. 17 is a perspective exploded view of an oil strainer of a sixth embodiment.

FIG. 18 is a sectional view of the oil strainer of the sixth embodiment, taken along the same line as the line A-A of FIG. 1.

FIG. 19 is an enlarged sectional view of the oil strainer of FIG. 18.

FIG. 20 is a perspective view showing a stacked or laminated filtration element.

### DETAILED DESCRIPTION OF THE INVENTION

Embodiments of the present invention will be explained below with reference to the drawings.

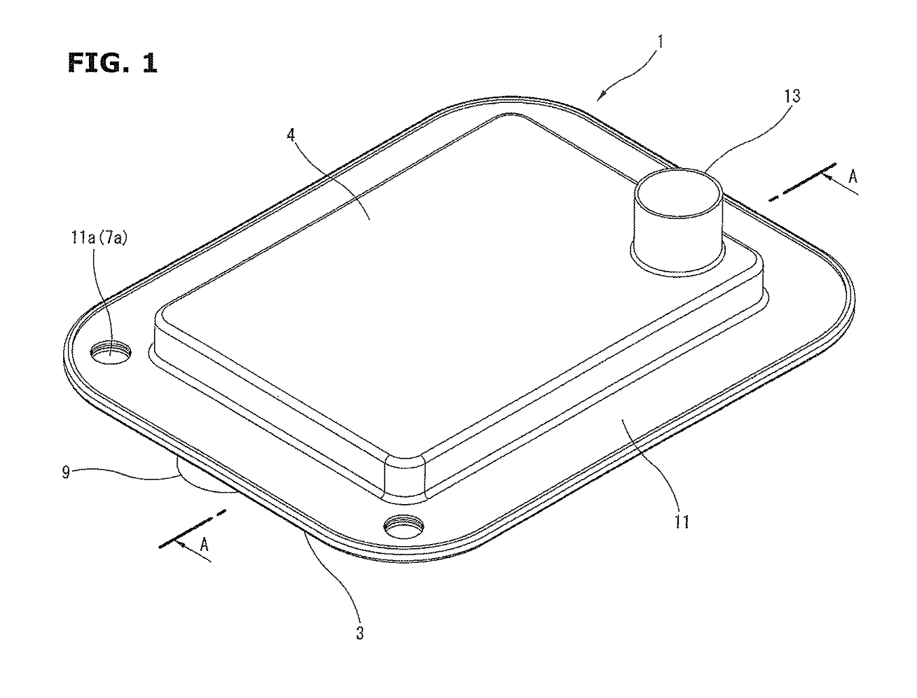

An oil strainer 1 of a first embodiment of the present invention will be explained below with reference to FIGS. 1 to 5. The oil strainer 1 of the present invention is used for, for instance, an automatic transmission of a vehicle.

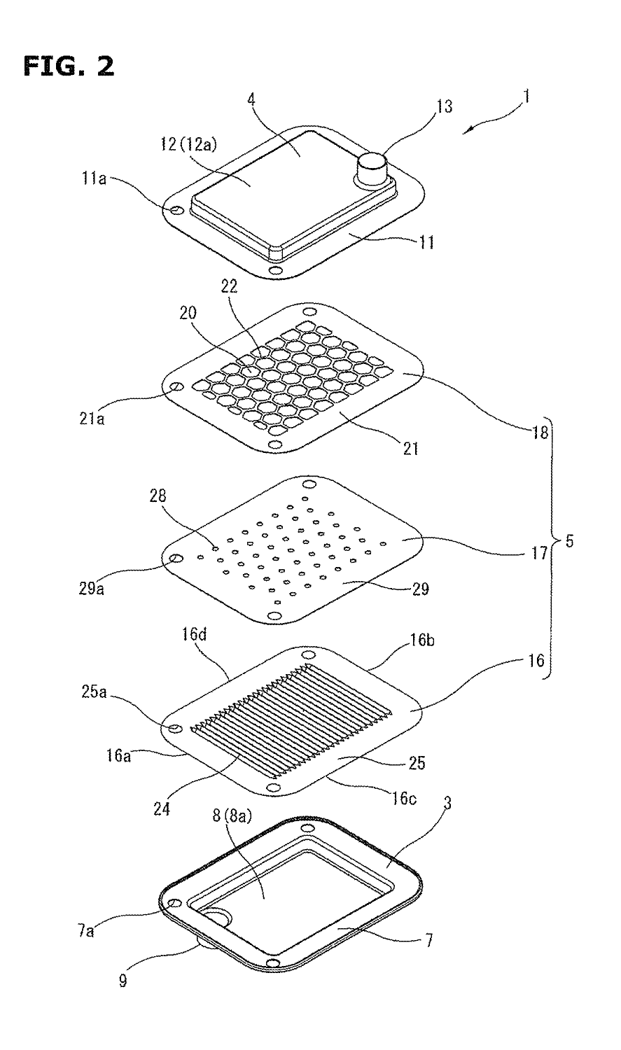

As shown in FIGS. 1 and 2, the oil strainer 1 is formed from metal-made lower and upper housings 3 and 4 that define an oil chamber 2 therebetween and a filtration element 5 that is sandwiched between the lower and upper housings 3 and 4 and divides the oil chamber 2 into a first oil chamber 2a at an upstream side and a second oil chamber 2b at a downstream side.

The lower housing 3 is formed into a substantially rectangular dish or pan shape whose upper surface is open. The lower housing 3 has a flange 7 formed along an entire circumference of this opening part and a dish portion 8 recessed so as to define the first oil chamber 2a. The dish portion 8 is provided on its bottom portion 8a with a cylindrical suction port 9 that protrudes outwards. The flange 7 has three mounting holes 7a into which a mounting bolt (not shown) is inserted.

Likewise, the upper housing 4 is formed into a substantially rectangular dish or pan shape whose lower surface is open. The upper housing 4 has a flange 11 having mounting holes 11a and a dish portion 12 recessed so as to define the second oil chamber 2b. The dish portion 12 is provided on its top portion 12a with a cylindrical discharge port 13 that protrudes outwards. This discharge port 13 is positioned so as to be located on a diagonal line of the suction port 9 in an assembly state of the oil strainer 1. That is, the discharge port 13 is offset from the suction port 9.

The filtration element 5 is formed from a first filtration member 16 having a coarse filter, a second filtration member 17 stacked or laminated at a downstream side of the first filtration member 16 and having a fine filter and a grid-shaped retainer plate (or a grating retainer plate) 18 stacked or laminated at a downstream side of the second filtration member 17 and retaining the filtration members 16 and 17.

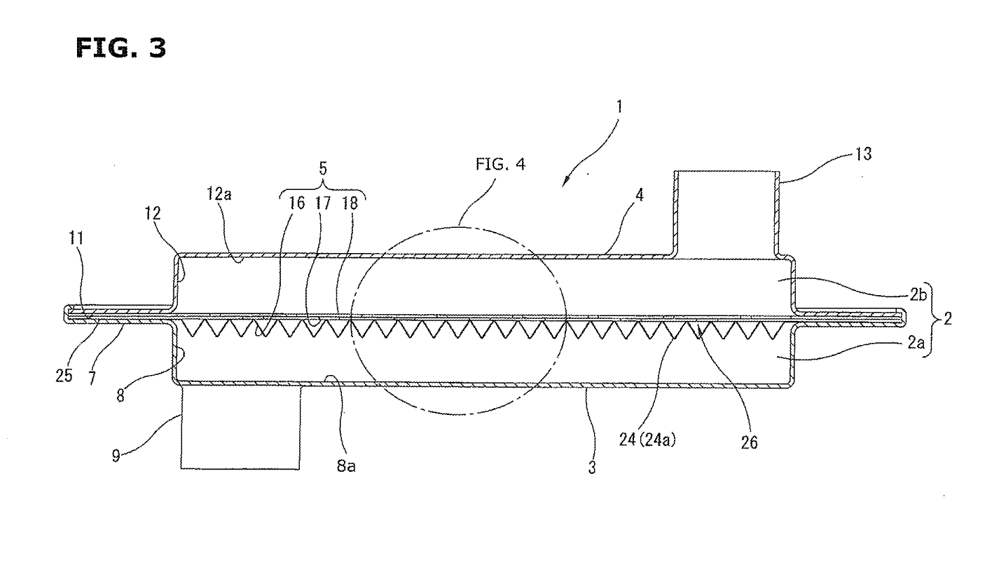

As shown in FIGS. 2 and 3, the retainer plate 18 is formed from a flat metal plate, and has a substantially rectangular shape whose outline is almost identical with an outside edge of the flange 11. The retainer plate 18 has a number of oil pass openings 20 that open in a middle area corresponding to the first and second oil chambers 2a and 2b and an outer peripheral portion 21 corresponding to the flanges 7 and 11 which is provided around the middle area of the oil pass opening 20. The oil pass openings 20 are formed so that thin beams (or narrow beams) 22 are left in the middle area. Each of the oil pass openings 20 has a polygonal shape (e.g. a hexagon). The outer peripheral portion 21 is provided with three mounting holes 21a corresponding to the mounting holes 7a and 11a.

The first filtration member 16 is formed from a metal mesh (wire gauze, wire netting, wire mesh and the like), and has a substantially rectangular shape whose outline is almost identical with an outside edge of the retainer plate 18. The first filtration member 16 has a plurality of pleats (protruding and depressed portions) 24 provided in a middle area (a filtering area) corresponding to the first oil chamber 2a and an outer peripheral portion 25 provided around the middle area of the pleats 24. The outer peripheral portion 25 is provided with three mounting holes 25a.

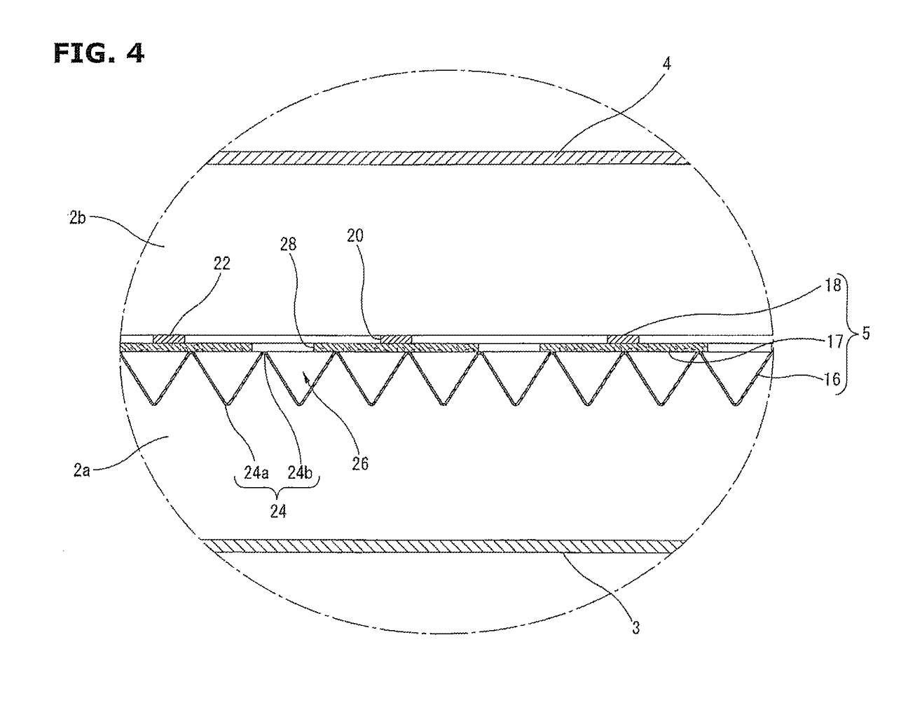

The pleats 24 are arranged parallel to each other in the middle area between one short side portion 16a and the other short side portion 16b. Further, the pleats 24 continuously extend in the middle area between one long side portion 16c and the other long side portion 16d. The pleats 24 have the function of separating the first filtration member 16 and the second filtration member 17 and also defining oil passages 26 (see FIGS. 3 and 4) that lead the oil to a direction orthogonal to a stacking direction of the filtration element 5. In addition, the pleats 24 serve to improve rigidity of the first filtration member 16.

As shown in FIGS. 3 and 4, each pleat 24 has a substantially V-shaped cross section that protrudes toward the first oil chamber 2a. More specifically, a top portion 24b of the pleat 24 is positioned on the same plane as the outer peripheral portion 25, whereas a valley portion 24a of the pleat 24 is positioned in a one-step-lower position than the outer peripheral portion 25. The pleats 24 are equal in height, and widths between the adjoining pleats 24 are set to be equal. Therefore, the oil passages 26 defined by and between the pleats 24 are equal in height and width. The pleat 24 is formed by shaping base material of the first filtration member 16 into an undulate shape (or a wavy form) by a bending or folding process (a pleating process).

The second filtration member 17 is formed from a nonwoven fabric sheet, and has a substantially rectangular shape whose outline is almost identical with an outside edge of the first filtration member 16. The second filtration member 17 has a number of circular opening portions 28 opening in a middle filtering area and an outer peripheral portion 29 provided around the middle filtering area of the opening portions 28. The outer peripheral portion 29 is provided with mounting holes 29a.

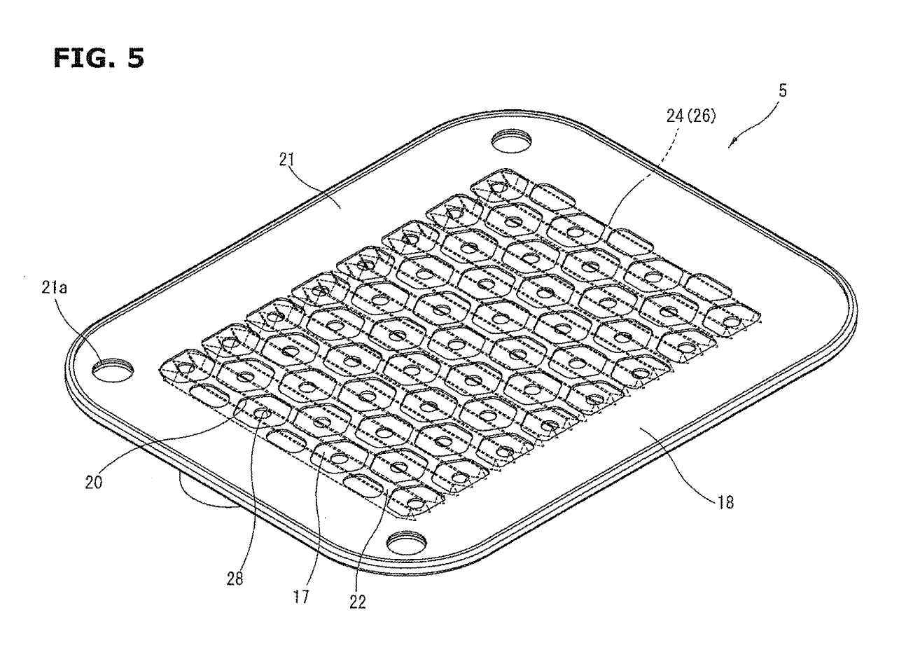

Each opening portion 28 is formed so as to allow a flow of the oil that bypasses the second filtration member 17. The plurality of opening portions 28 are arranged uniformly at regular intervals in the filtering area so as to range over the area of the pleat 24 when the filtration element 5 is stacked. As shown in FIG. 5, an opening area of each opening portion 28 is set according to the proportion of the oil bypassing the second filtration member 17, and this opening area is smaller than that of the oil pass opening 20. In order for the bypassing oil to smoothly flow through the oil pass openings 20, the opening portions 28 are arranged on the second filtration member 17 so as to be located in substantially center positions of the respective oil pass openings 20 in a stacking state.

The filtration element 5 formed as above is held between the upper and lower housings 4 and 3, as shown in FIGS. 3 and 4. More specifically, the first filtration member 16 is disposed on the lower housing 3, and the second filtration member 17 and the retainer plate 18 are stacked on the first filtration member 16 in this order, then the upper housing 4 is stacked on the retainer plate 18. By crimping the flange 7 of the lower housing 3 so as to sandwich the flange 11 and the outer peripheral portions 21, 25 and 29 (by folding an outer edge of the flange 7 of the lower housing 3 so as to fix the flange 11 and the outer peripheral portions 21, 25 and 29), the filtration element 5 is held and fixed between the flange 7 and the flange 11, then the oil strainer 1 is assembled.

In the assembly state of the oil strainer 1, the pleats 24, the opening portions 28 and the oil pass openings 20 are arranged substantially uniformly on the entire surfaces of the first and second oil chambers 2a and 2b. The first filtration member 16 is stacked on the second filtration member 17 (the second filtration member 17 is stacked on the first filtration member 16) with the valley portion 24a of the pleat 24 of the first filtration member 16 protruding toward the first oil chamber 2a and with the top portion 24b of the pleat 24 touching the second filtration member 17. With this, the first filtration member 16 and the second filtration member 17 are held with the valley portion 24a and the second filtration member 17 being separate, then this separate space or room acts as the oil passage 26.

As can be seen from FIG. 5, each of the oil passages 26 (shown by a broken line) formed by the pleats 24 communicates with the opening portion 28. In the present embodiment, one oil passage 26 communicates with three or four opening portions 28. With this arrangement, the oil flows along the passages 26, then bypasses the second filtration member 17 through the respective opening portions 28. Further, as mentioned above, each of the opening portions 28 of the second filtration member 17 is located in substantially center position of the oil pass opening 20. That is, one oil pass opening 20 corresponds to one opening portion 28.

Next, the oil flow in the oil strainer 1 will be explained.

The oil in an oil pan (not shown) is pumped up by an oil pump (not shown), and flows into the oil strainer 1 (the first oil chamber 2a) from the suction port 9. The oil then passes through the first filtration member 16 through an inclination part of the pleat 24, and flows into the oil passage 26. At this time, a relatively large foreign matter is caught or trapped by the first filtration member 16. Since the suction port 9 and the discharge port 13 are arranged on the diagonal line, the oil pumped up and flowing into the oil strainer 1 through the suction port 9 flows in a direction of the diagonal line from a corner where the suction port 9 is provided to a corner where the discharge port 13 is provided. As a consequence, the oil flows while passing through the first filtration member 16 and spreading over the first filtration member 16.

Subsequently, the oil in the oil passage 26 flows while passing through the second filtration member 17. At this time, minute or fine foreign matter that has not been caught by the first filtration member 16 is caught or trapped by the second filtration member 17. And, a part of the oil flows along the oil passage 26, and bypasses the second filtration member 17 through the opening portion 28 corresponding to this oil passage 26. Especially when a viscosity of the oil is high, e.g. when an engine does not warm-up, most of the oil bypasses the second filtration member 17 through the opening portion 28 without passing through the second filtration member 17.

Afterwards, the oil flows into the second oil chamber 2b through the oil pass opening 20, and flows out of the oil strainer 1 through the discharge port 13.

According to the present embodiment, by providing the plurality of opening portions 28 on the second filtration member 17, it is possible to surely catch the foreign matter by the two kinds of filtration members each having a different grain while reducing a resistance of an oil flow passage. Further, since the first filtration member 16 and the second filtration member 17 are separately held by the plurality of pleats 24 provided at the first filtration member 16, there is no need to provide spacers that are additional elements or components. This contributes to further reduction of the resistance of the oil flow passage. In addition, an entire area of the filtration area can be used for the filtration.

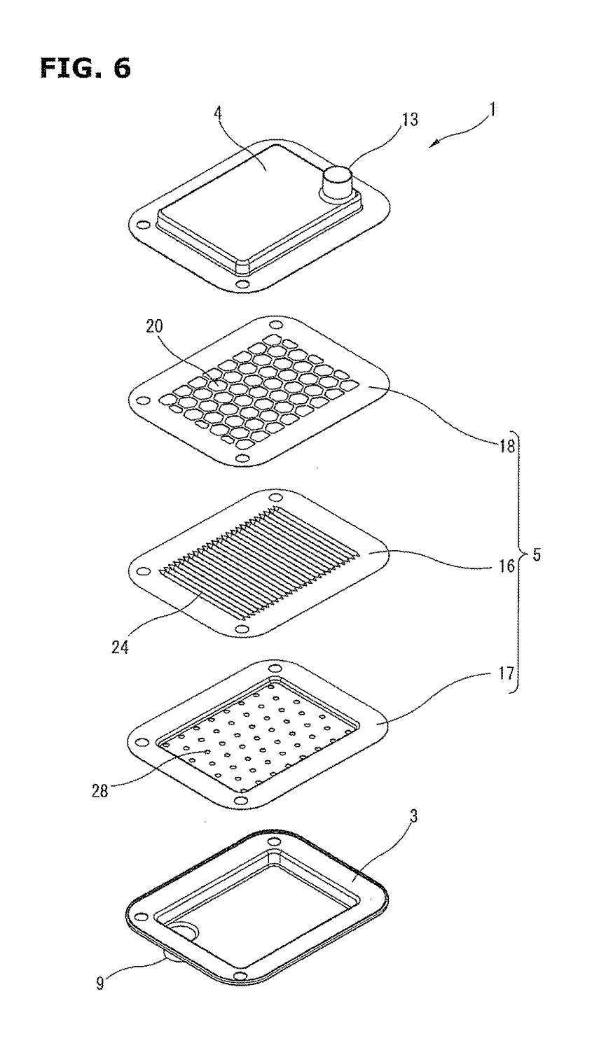

Next, other embodiment will be explained below with reference to FIGS. 6 to 8. Here, structures of the lower housing 3, the upper housing 4 and the retainer plate 18 are the same as those of the first embodiment. Further, unless difference of the filtration member is described, structures of the first filtration member 16 and the second filtration member 17 are the same as those of the first embodiment.

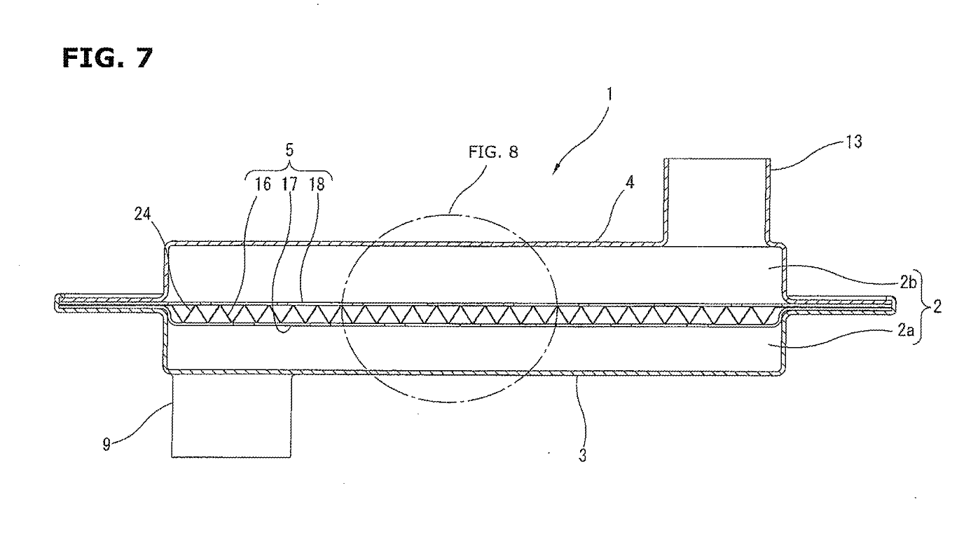

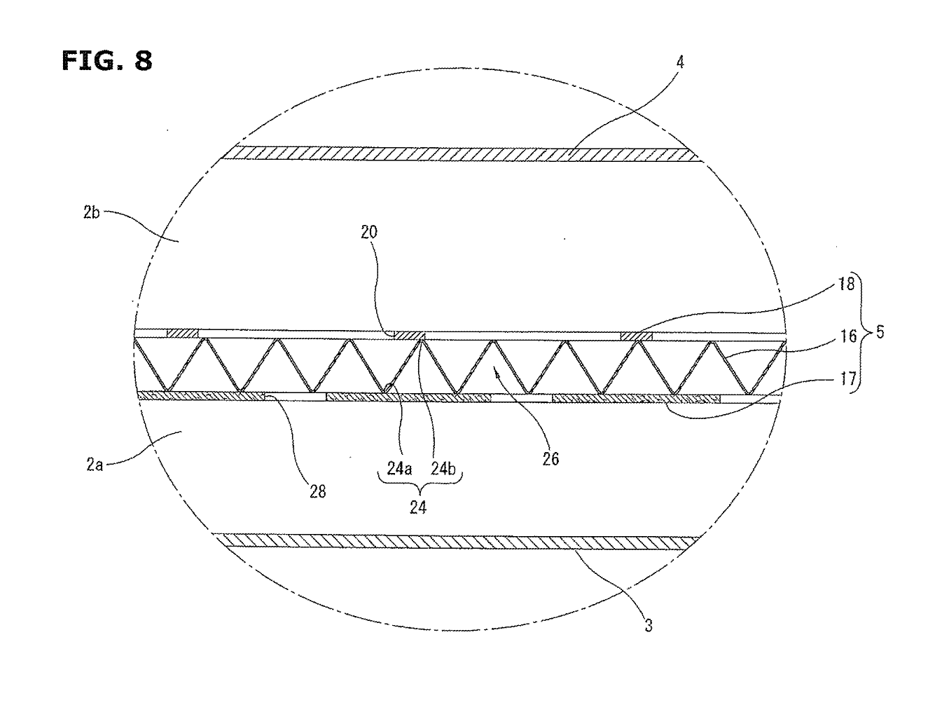

FIG. 6 is a perspective exploded view of the oil strainer 1 of a second embodiment. FIG. 7 is a sectional view of the oil strainer 1 of the second embodiment, taken along the same line as the line A-A of FIG. 1. FIG. 8 is an enlarged sectional view of the oil strainer of FIG. 7.

In the present embodiment, the second filtration member 17 having the fine filter is disposed at an upstream side of the oil flow, and the first filtration member 16 having the coarse filter is stacked at a downstream side of the second filtration member 17, then the retainer plate 18 is stacked at a downstream side of the first filtration member 16.

As shown in FIGS. 7 and 8, in the assembly state of the oil strainer 1, the first filtration member 16 is held between the second filtration member 17 and the retainer plate 18 with the top portion 24b of the pleat 24 touching the retainer plate 18 and with the valley portion 24a of the pleat 24 touching the second filtration member 17. With this, the first filtration member 16 and the second filtration member 17 are held with the top portion 24b and the second filtration member 17 being separate, then this separate space or room acts as the oil passage 26.

In the oil strainer 1 formed as above, the oil flowing into the first oil chamber 2a flows while passing through the second filtration member 17, and the minute or fine foreign matter is caught or trapped by the second filtration member 17. And, a part of the oil bypasses the second filtration member 17 through the opening portion 28. This bypassing oil flows while passing through the first filtration member 16 together with the oil passing through the second filtration member 17. At this time, remaining foreign matter is caught or trapped by the first filtration member 16. Afterwards, the oil flows into the second oil chamber 2b through the oil pass opening 20, and flows out of the oil strainer 1 through the discharge port 13.

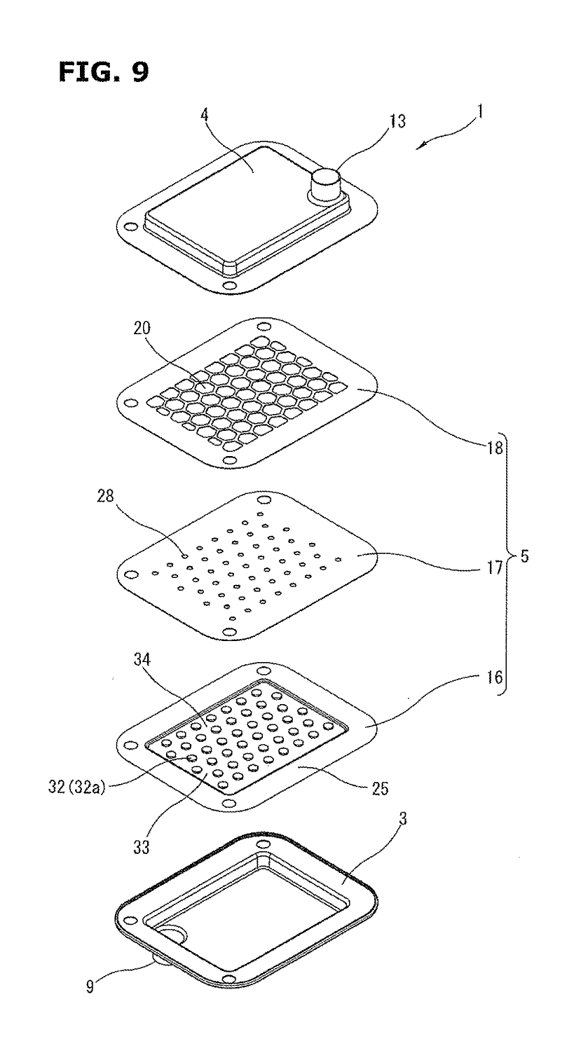

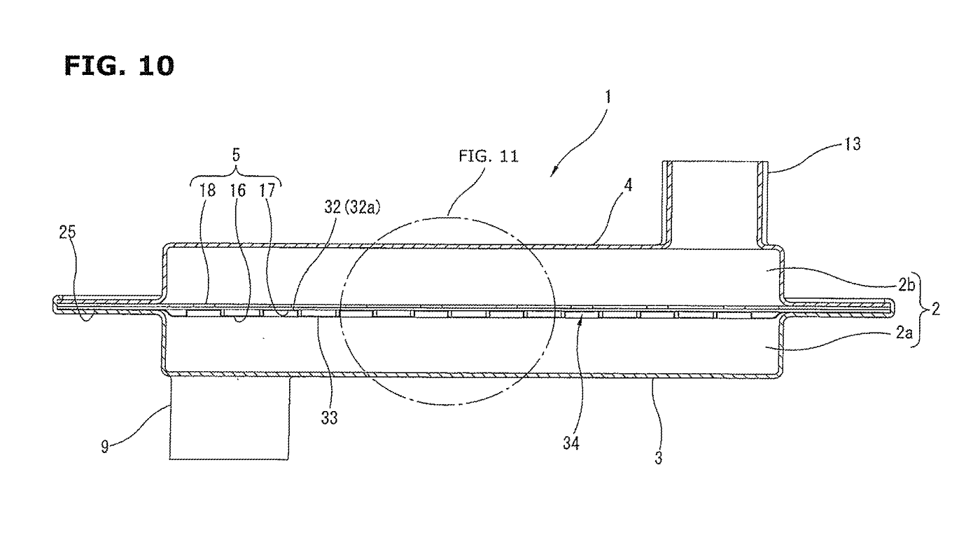

Next, the oil strainer 1 of a third embodiment will be explained below with reference to FIGS. 9 to 12.

In the present embodiment, the first filtration member 16 has a plurality of protrusions (protruding and depressed portions) 32 instead of the plurality of pleats 24.

As shown in FIG. 9, regarding the first filtration member 16 formed from the metal mesh, its middle filtering area corresponding to the first oil chamber 2a is recessed to a one-step-lower position than the outer peripheral portion 25. The plurality of protrusions 32 are formed on a bottom portion 33 of the recessed middle area so as to protrude toward the second filtration member 17. Each protrusion 32 has a circular shape. The protrusions 32 are equal in height. A top surface 32a of the protrusion 32 is positioned on the same plane as the outer peripheral portion 25. The protrusions 32 have the function of separating the first filtration member 16 and the second filtration member 17 and also defining oil passages 34 between the first filtration member 16 and the second filtration member 17 (between the protrusions 32). In addition, the protrusions 32 serve to improve rigidity of the first filtration member 16. The plurality of protrusions 32 are formed by an embossing process of the base material of the first filtration member 16.

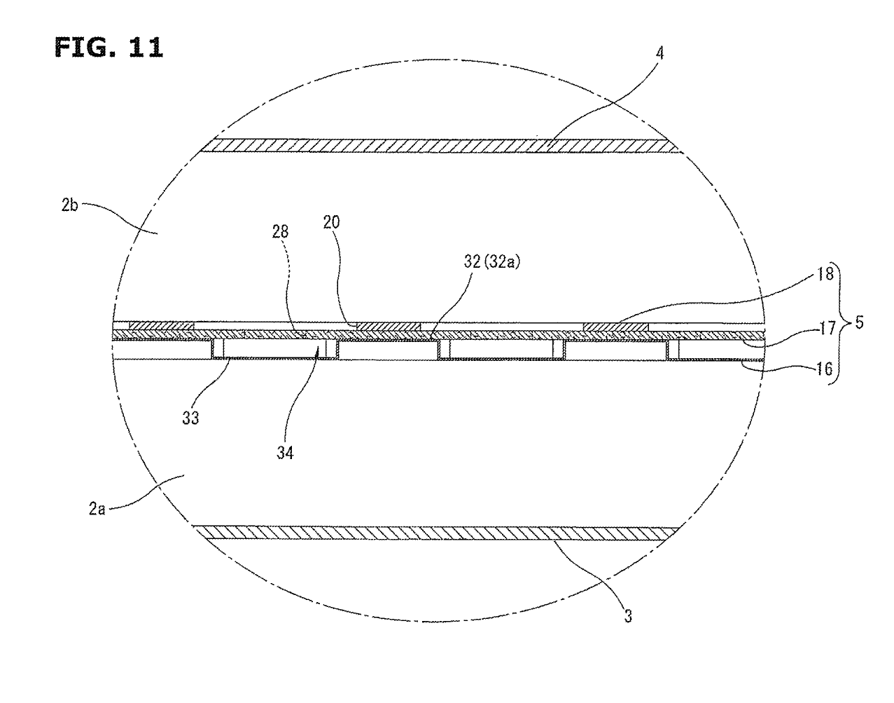

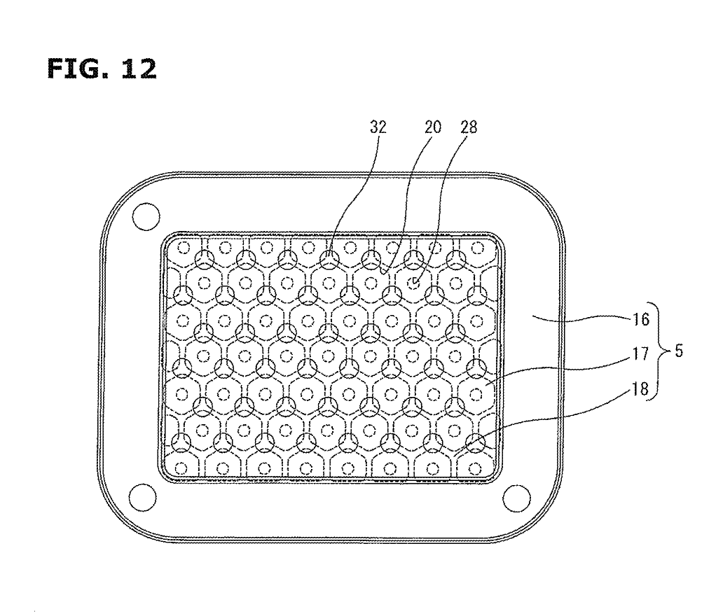

As shown in FIGS. 11 and 12, in the stacking state of the filtration element 5, the top surface 32a of the protrusion 32 touches the second filtration member 17 around the opening portions 28 (shown by a broken line). With this, the first filtration member 16 and the second filtration member 17 are held with the bottom portion 33 and the second filtration member 17 being separate, then this separate space or room acts as the oil passage 34.

In the oil strainer 1 formed as above, the oil passes through the first filtration member 16, and flows into the oil passage 34. At this time, a relatively large foreign matter is caught or trapped by the first filtration member 16. Subsequently, the oil in the oil passage 34 flows while passing through the second filtration member 17. At this time, minute or fine foreign matter is caught or trapped by the second filtration member 17. And, a part of the oil flows along the oil passage 34, and bypasses the second filtration member 17 through the opening portion 28. Afterwards, the oil flows out of the oil strainer 1 through the discharge port 13.

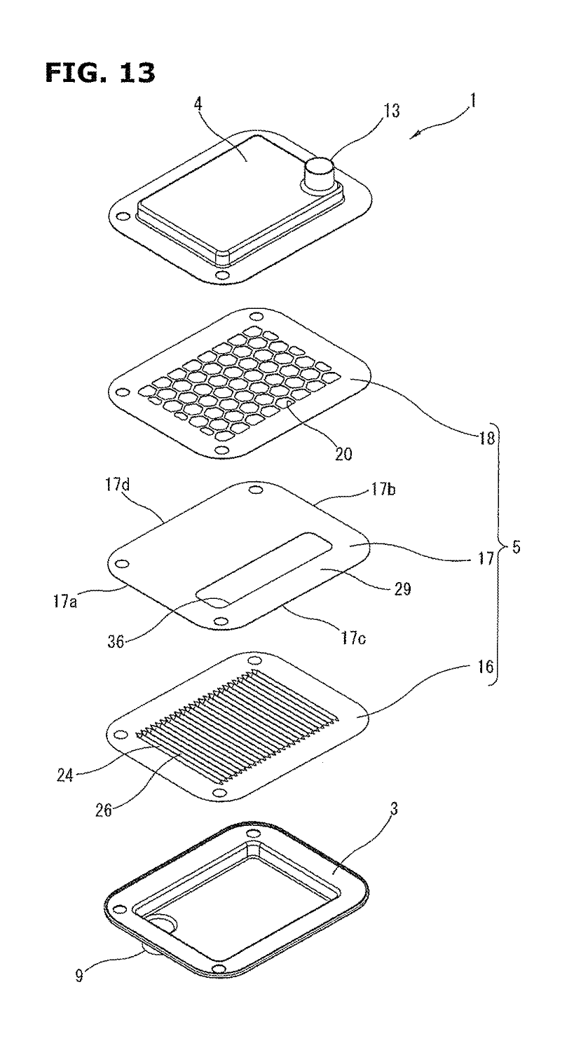

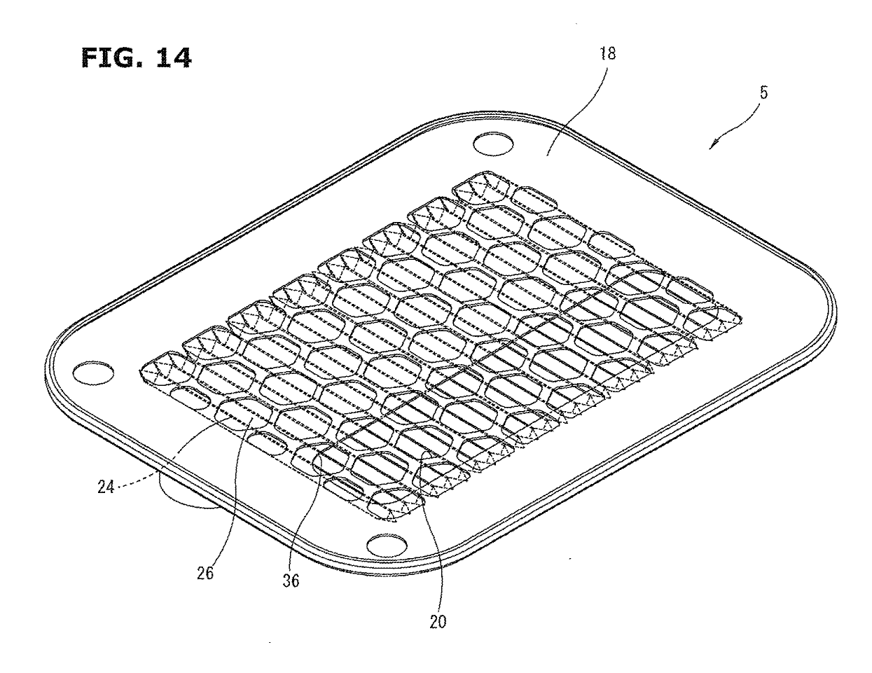

Next, the oil strainer 1 of a fourth embodiment will be explained below with reference to FIGS. 13 and 14.

In the present embodiment, the second filtration member 17 has one rectangular opening 36 instead of the plurality of opening portions 28. The opening 36 is located at a side of one long side portion 17c of the substantially rectangular second filtration member 17. More specifically, the opening 36 extends between one short side portion 17a and the other short side portion 17b by a predetermined length and extends between the one long side portion 17c and the other long side portion 17d by a predetermined width so that the outer peripheral portion 29 is left.

In the assembly state of the oil strainer 1, the opening 36 is located directly below the discharge port 13. As shown in FIG. 14, the opening 36 extends in a direction orthogonal to the pleat 24 of the first filtration member 16, and communicates with almost all pleats 24, i.e. almost all oil passages 26. Further, the opening 36 communicates with a plurality of rows (e.g. three rows) of the oil pass openings 20 which are located at the side of the one long side portion 17c.

In the oil strainer 1 formed as above, the oil flowing into the first oil chamber 2a flows while passing through the first filtration member 16 and the second filtration member 17, and foreign matter is caught or trapped by these first and second filtration members 16 and 17. On the other hand, a part of the oil passing through the first filtration member 16 flows to the one long side portion 17c side toward the opening 36 along the oil passage 26, and bypasses the second filtration member 17 through the opening 36. The bypassing oil flows to a downstream side toward the discharge port 13 that is located directly above the opening 36, and flows out of the oil strainer 1 through the discharge port 13 together with the oil passing through the second filtration member 17.

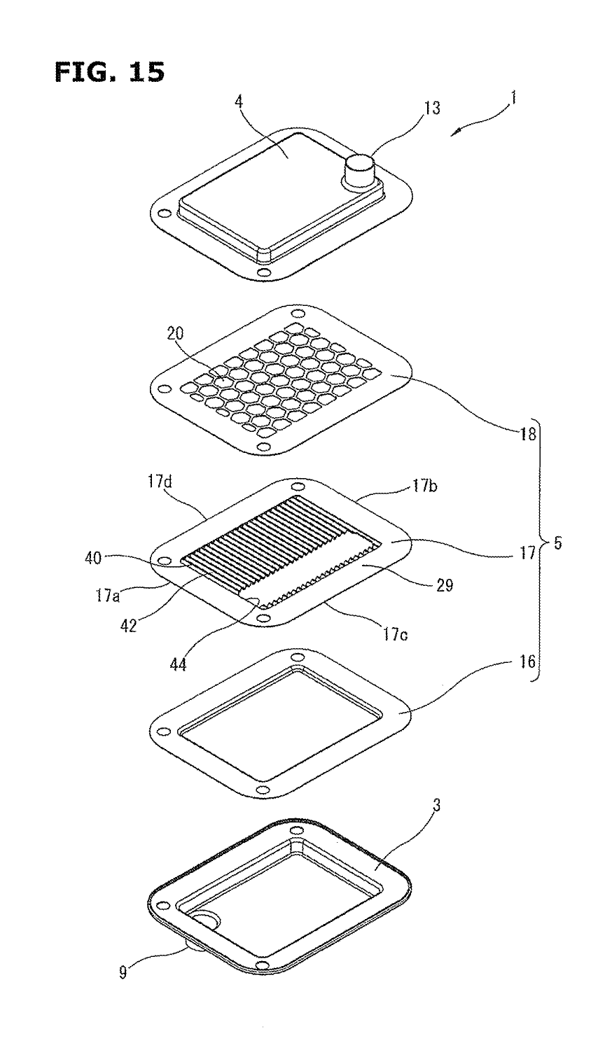

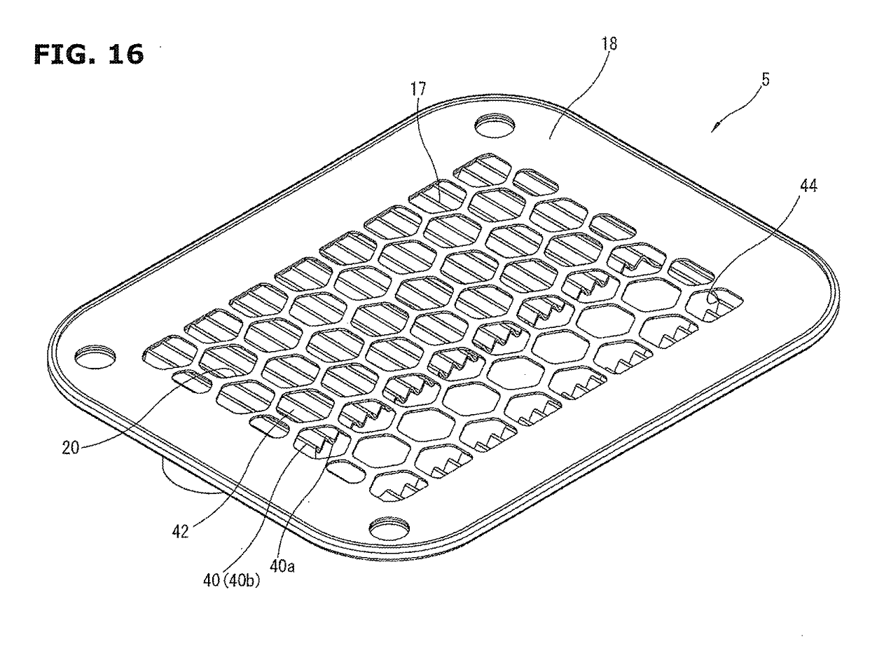

Next, the oil strainer 1 of a fifth embodiment will be explained below with reference to FIGS. 15 and 16.

In the present embodiment, instead of the first filtration member 16, the second filtration member 17 is provided with a plurality of pleats (protruding and depressed portions) 40. The first filtration member 16 is formed from a metal mesh, and a middle part of the first filtration member 16 is recessed so as to receive or accommodate the pleats 40.

The second filtration member 17 formed from a nonwoven fabric has the plurality of pleats 40 provided in a middle filtering area and an outer peripheral portion 29 provided around the middle filtering area of the pleats 40. The pleats 40 are the same as the pleats 24 of the first embodiment. The pleats 40 are arranged parallel to each other in the middle area between one short side portion 17a and the other short side portion 17b. Further, the pleats 40 extend in the middle area between one long side portion 17c and the other long side portion 17d. The pleats 40 are formed so as to separate the first filtration member 16 and the second filtration member 17 and so as to define oil passages 42 between the pleats 40. The pleat 40 is formed by shaping base material of the second filtration member 17 into an undulate shape (or a wavy form) by a bending or folding process (a pleating process).

Further, the second filtration member 17 has a rectangular opening 44 at a side of the one long side portion 17c. This opening 44 is the same as the opening 36 of the fourth embodiment. The opening 44 extends in a direction orthogonal to the pleat 40, and extends between the one long side portion 17c and the other long side portion 17d by a predetermined width. The oil passages 42 between the pleats 40 open toward this opening 44.

In the assembly state of the oil strainer 1, the second filtration member 17 is stacked between the first filtration member 16 and the retainer plate 18 with a valley portion 40a of the pleat 40 touching the first filtration member 16 and with a top portion 40b of the pleat 40 touching the retainer plate 18. With this, the first filtration member 16 and the second filtration member 17 are held with the top portion 40b and the first filtration member 16 being separate, then this separate space or room acts as the oil passage 42. The opening 44 overlaps with a part of the plurality of oil pass openings 20 of the retainer plate 18.

In the oil strainer 1 formed as above, a part of the oil passing through the first filtration member 16 flows to the one long side portion 17c side toward the opening 44 through the oil passage 42, and bypasses the second filtration member 17 through the opening 44. The bypassing oil flows to a downstream side toward the discharge port 13 that is located directly above the opening 44, and flows out of the oil strainer 1 through the discharge port 13 together with the oil passing through the second filtration member 17.

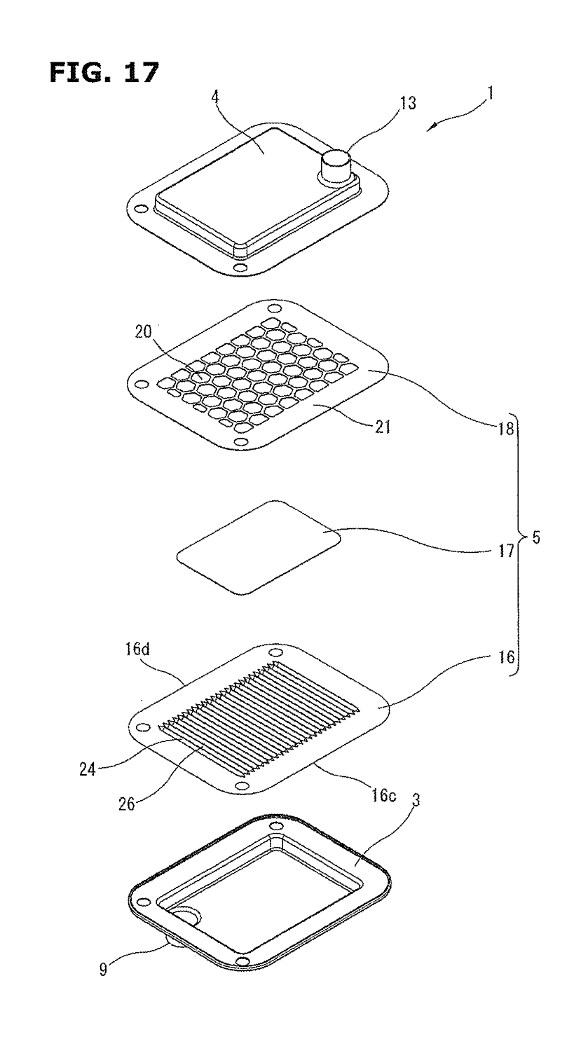

Next, the oil strainer 1 of a sixth embodiment will be explained below with reference to FIGS. 17 to 20.

The second filtration member 17 formed from a nonwoven fabric has an outside shape that is smaller than the filtering area of the first filtration member 16. That is, the second filtration member 17 overlaps with only a part of the pleats 24 of the first filtration member 16 and a part of the oil pass openings 20 of the retainer plate 18 (the second filtration member 17 overlaps partly with the pleats 24 of the first filtration member 16 and the oil pass openings 20 of the retainer plate 18).

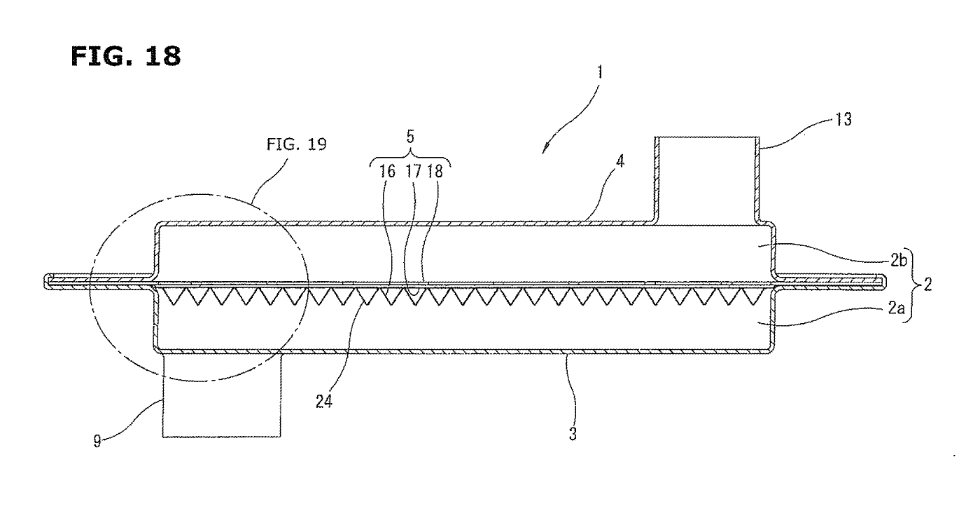

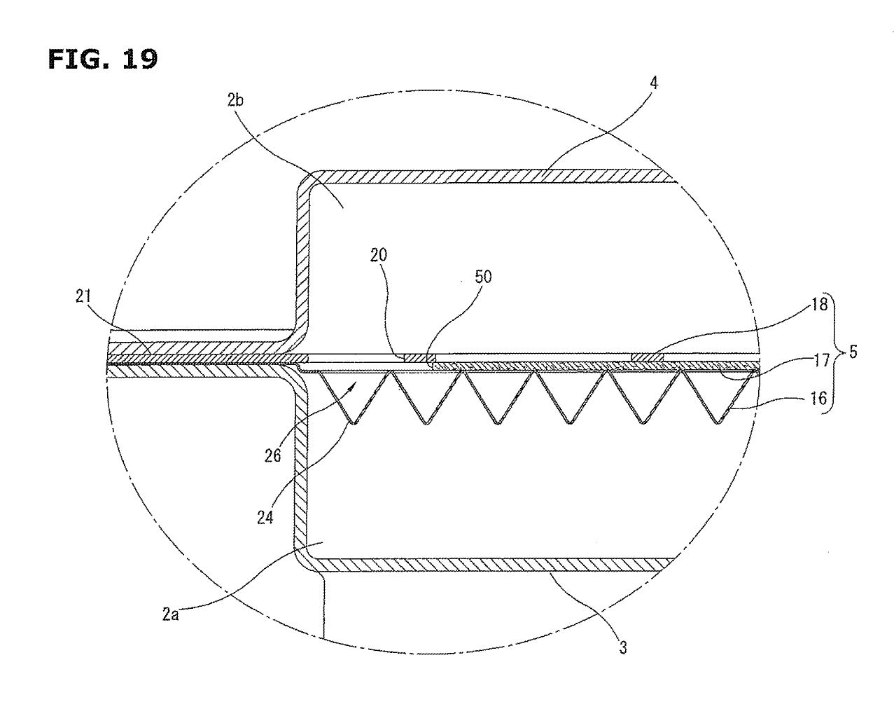

As shown in FIGS. 18 and 19, the second filtration member 17 formed as above is held between the first filtration member 16 and the retainer plate 18. More specifically, the second filtration member 17 is stacked on the first filtration member 16 so that the second filtration member 17 is located in the middle of the filtering area where the pleats 24 are provided, and the retainer plate 18 is stacked on the second filtration member 17 so that some oil pass openings 20 are located at an outer circumferential side of the second filtration member 17.

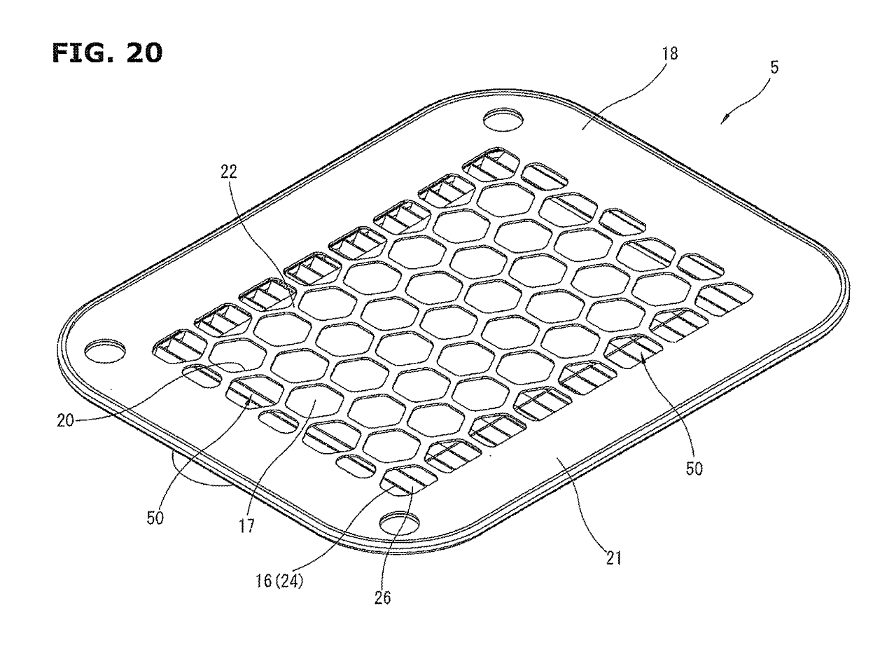

By arranging the second filtration member 17 with respect to the first filtration member 16 and the retainer plate 18 in this manner, in the assembly state of the oil strainer 1, an opening 50 allowing a flow of the oil that bypasses the second filtration member 17 is defined along an entire circumference of the second filtration member 17 (see FIG. 20). The opening 50 communicates with each passages 26 between the pleats 24, and overlaps with the oil pass openings 20 arranged along the outer peripheral portion 21 of the retainer plate 18.

In the oil strainer 1 formed as above, the oil flowing into the first oil chamber 2a flows while passing through the first filtration member 16 and the second filtration member 17, and foreign matter is caught or trapped by these first and second filtration members 16 and 17. On the other hand, a part of the oil passing through the first filtration member 16 flows to the one long side portion 16c and the other long side portion 16d toward the opening 50 along the oil passage 26, and bypasses the second filtration member 17 through the opening 50, then flows toward an upstream side. Further, after flowing into the second oil chamber 2b through the oil pass openings 20 arranged along the outer peripheral portion 21 of the retainer plate 18, the oil flows out of the oil strainer 1 through the discharge port 13 together with the oil passing through the second filtration member 17.

The present invention is not limited to the structure or configuration of the above embodiments. For instance, shapes of the oil pass opening 20, the openings 28, 36, 44 are not limited to those in the above embodiments. Further, in the above embodiments, although the lower housing 3 and the upper housing 4 are made of metal, these could be made of synthetic resin. Moreover, the oil strainer 1 of the present invention can be used for an internal combustion engine and a variety of hydraulic equipment.

The entire contents of Japanese Patent Application No. 2015-151412 filed on Jul. 31, 2015 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. An oil strainer comprising:
a housing having a suction port and a discharge port; and
a filtration element dividing an inside of the housing into a suction port side and a discharge port side, the filtration element being set so that oil flows from the suction port to the discharge port through the filtration element, the filtration element having;
(a) a first filtration member having a coarse filter;
(b) a second filtration member having a fine filter, the second filtration member being stacked at an upstream side or a downstream side of the first filtration member; and
(c) a retainer plate having a plurality of oil pass openings and retaining the first and second filtration members, the retainer plate being stacked at a downstream side of the first and second filtration members, and
wherein
the second filtration member has at least one opening portion so that a part of the oil bypasses the second filtration member, and
one of the first and second filtration members has protruding and depressed portions that touch the other of the first and second filtration members.

2. The oil strainer as claimed in claim 1, wherein:
the protruding and depressed portions are a plurality of pleats, and
oil passages defined between the pleats each communicate with the opening portion.

3. The oil strainer as claimed in claim 1, wherein:
the first filtration member is formed from a metal mesh and is disposed at the suction port side, and
the second filtration member is formed from a nonwoven fabric and is disposed at the downstream side of the first filtration member.

4. The oil strainer as claimed in claim 1, wherein:
the second filtration member has a plurality of opening portions that are arranged so that the opening portions each correspond to the oil pass openings of the retainer plate.

5. The oil strainer as claimed in claim 1, wherein:
the second filtration member has an opening portion that extends so as to partly communicate with oil pass openings.
